(19) United States
(12) Patent Application Publication
(10) Pub. No.: US 2009/0242290 A1
(43) Pub. Date: Oct. 1, 2009

(54) DRIVE CONTROL DEVICE

(75) Inventor: Yasuhiko KOBAYASHI, Anjo-shi (JP)

Correspondence Address: SUGHRUE MION, PLLC, 2100 PENNSYLVANIA AVENUE, N.W., SUITE 800, WASHINGTON, DC, 20037, US

(73) Assignee: AISIN AW CO., LTD., Anjo-shi (JP)

(21) Appl. No.: 12/406,286

(22) Filed: Mar. 18, 2009

(30) Foreign Application Priority Data
Mar. 28, 2008 (JP) 2008-087884

(51) Int. Cl. B60W 20/00

(52) U.S. Cl. 180/65.265

(57) ABSTRACT

A drive control device for a drive unit has a mechanical pump operated by a rotational driving force of a drive member drivingly connected with a drive power source, an electric pump that supplements the mechanical pump, and an electric pump driver that controls a drive current to a motor of the electric pump. The drive control unit is also provided with a driver temperature evaluation unit that evaluates a temperature of the electric pump driver, and an electric pump control unit that cuts off a power source of the electric pump driver if it is determined by the driver temperature evaluation unit during operation of the electric pump driver that a prescribed first warning state, which is a state pertaining to the temperature of the electric pump driver, has been reached.

### INCORPORATION BY REFERENCE

The disclosure of Japanese Patent Application No. 2008-087884 filed on Mar. 28, 2008 including the specification, drawings and abstract is incorporated herein by reference in its entirety.

### BACKGROUND OF THE INVENTION

Aspects and features of the present invention relate to a drive control device for a drive unit having a drive member operatively connected with a drive power source, a mechanical pump operated by a rotational driving force of the drive member, an electric pump that supplements or operates alternatively with the mechanical pump, and an electric pump driver that controls a drive current to a motor of the electric pump.

### DESCRIPTION OF THE RELATED ART

Known related art includes a drive control device of a drive unit for a vehicle, as disclosed in Japanese Patent Application Publication No. JP-A-2003-172444 (see paragraphs 0114 to 0118, and FIGS. 2, 3, 4 and 6) for example, wherein the drive unit for a vehicle is provided with an engine and a motor/generator (reference numerals 5 and 6 in FIG. 2 of Japanese Patent Application Publication No. JP-A-2003-172444) as drive power sources. The drive control device of Japanese Patent Application Publication No. JP-A-2003-172444 is structured such that, if a rotational speed of the engine falls to or below a predetermined rotational speed and the mechanical pump functions inadequately as a result, then the electric pump (reference numeral 11 in FIG. 2 of Japanese Patent Application Publication No. JP-A-2003-172444) is driven to supply oil from the electric pump to a hydraulic control device (reference numeral 9 in FIG. 2 of Japanese Patent Application Publication No. JP-A-2003-172444), which enables engagement of a clutch (reference numeral C1 in FIG. 3 of Japanese Patent Application Publication No. JP-A-2003-172444) of an automatic transmission (reference numeral 8 in FIG. 2 of Japanese Patent Application Publication No. JP-A-2003-172444).

In a drive unit such as that disclosed in Japanese Patent Application Publication No. JP-A-2003-172444, the electric pump is used as a critical structural element for complementing the mechanical pump. This type of electric pump utilizes the rotational driving force of a motor in order to generate the ability to supply pressurized oil, and a motor driver is used to supply a motor drive current for controlling the motor. A large current flows through the motor driver which causes the motor driver to generate considerable heat. Further, the motor driver also receives external heat from the motor and so forth. Especially in cases where the drive unit is mounted in a vehicle such as an automobile or the like, any cooling dependent upon the movement of the automobile is disrupted when the automobile is stopped. As a consequence, the motor driver may be subjected to high heat with the potential to cause an operational failure. For a vehicle that performs idling stops, the engine fan may also be stopped during the idling stop. This temporarily results in a considerably high temperature in the vicinity of the engine due to engine heat, which obviously creates a severe heat condition for the motor driver. However, implementing cooling countermeasures for a motor driver that may be used under such a severe heat condition, such as a structural modification or a layout modification, creates a burden in terms of cost and space.

### SUMMARY OF THE INVENTION

In light of the foregoing situation, it is an aspect of the present invention to provide a drive control device that protects a driver for an electric pump motor without implementing a heat countermeasure through a structural modification or a layout modification. The various embodiments of the present invention overcome the above disadvantages and other disadvantages not described above. Also, the present invention is not required to overcome the disadvantages described above, and an exemplary embodiment of the present invention may not overcome any of the problems described above.

In order to achieve the above, a drive control device for a drive unit according to one aspect of the present invention includes: a drive member operatively connected with a drive power source; a mechanical pump operated by a rotational driving force of the drive member; an electric pump that supplements the mechanical pump; and an electric pump driver that controls a drive current to a motor of the electric pump. A characteristic configuration of the drive control device further includes: a driver temperature evaluation unit that evaluates a temperature of the electric pump driver; and an electric pump control unit that cuts off a power source of the electric pump driver if it is determined by the driver temperature evaluation unit during operation of the electric pump driver that a prescribed first warning state, which is a state pertaining to the temperature of the electric pump driver, has been reached.

Note that in the present application, the drive power source includes an engine and a rotary electric machine, wherein the concept of the rotary electric machine includes a motor, generator, and a motor/generator that carries out both the functions of a motor and a generator as necessary.

According to this characteristic configuration, the driver temperature evaluation unit evaluates a temperature state of the electric pump driver. If the driver temperature evaluation unit determines that the temperature state corresponds to the first warning state, then the electric pump control unit cuts off the power source of the electric pump driver. Thus, the electric pump driver stops generating heat, making it possible to avoid a further increase in the temperature of the electric pump driver that may result in an operation failure. If the electric pump driver reaches a warning temperature state in this manner, then the adoption of a structure that cuts off the power source of the electric pump driver in a controlled manner eliminates the need for a heat countermeasure involving hardware, such as a structural modification or a layout modification, in order to handle such infrequent occurrences of high temperatures. Therefore, the problem of unnecessary cost increases can be avoided.

Here, if the driver temperature evaluation unit determines that a state pertaining to the temperature of the electric pump driver corresponds to the first warning state, then the mechanical pump is driven before cutting off the power source of the electric pump driver. Stopping of the electric pump as a result of cutting off the power source of the electric pump driver unit halts the pressurized oil supplied by the electric pump. However, according to this structure, the mechanical pump is driven to supply oil pressure before the electric pump is stopped, so that the oil supply pressure remains constant. In other words, even if the power source of the electric pump driver is cut off based on a determination of the first warning state when oil pressure is supplied by the electric pump, pressurize oil is supplied by the mechanical pump.

Further, in cases where a second warning state prescribed as a lower temperature state than the above mentioned first warning state is set, if the driver temperature evaluation unit determines that a state pertaining to the temperature of the electric pump driver corresponds to the second warning state, then the mechanical pump is driven and the motor of the electric pump is stopped. According to this structure, even if the urgency of the situation does not merit determination of the first warning state, the motor of the electric pump is stopped when a temperature state requiring caution is determined, whereby heat generated by the electric pump driver can be suppressed. As a consequence, there is an increased chance of ensuring that the temperature state of the electric pump driver does not deteriorate to the first warning state, without cutting off the power source of the electric pump driver. In other words, it is possible to reduce the frequency of an emergency response, namely, cutting off the power source of the electric pump driver. Note that in this case as well, the mechanical pump is driven when the motor of the electric pump is stopped so that the supply of pressurized oil from the electric pump is replaced by a supply of pressurized oil from the mechanical pump.

The driver temperature evaluation unit may be structured so as to determine a warning state based on a detected value for an internal temperature of the electric pump driver. With such a structure, direct detection of the internal temperature of the electric pump driver enables an accurate determination of a warning state pertaining to the temperature of the electric pump driver.

However, the internal temperature of the electric pump driver is sometimes difficult to directly detect. In cases where the drive unit is incorporated in a vehicle such as an automobile, it is possible to utilize detected values from temperature sensors that detect various environmental temperatures (temperatures at locations separate from the electric pump driver) that have a corresponding relation with the internal temperature of the electric pump driver. Accordingly, the driver temperature evaluation unit is may be configured to calculate an estimated value for the internal temperature of the electric pump driver based on an environmental temperature, and determine the warning state based on the estimated internal temperature of the electric pump driver. In particular, utilizing a detected value from a temperature sensor that is typically provided or associated with the drive unit is greatly advantageous in terms of cost, since there is no need to provide a mechanism for directly detecting the internal temperature of the electric pump driver.

If the drive unit is incorporated into a vehicle such as an automobile, then the environmental temperature may be any one of an outside air temperature, a coolant temperature of the drive power source, an oil temperature of the drive power source, or any combination thereof Namely, instead of directly detecting the temperature of the electric pump driver, the internal temperature of the electric pump driver is estimated from a temperature at another location, and determinations regarding the first warning state and the second warning state are made based on this estimated internal temperature. In particular, the estimated internal temperature may be derived from a combination of a plurality of environmental temperatures using a table of conditions created by a statistical technique such as regression analysis. In such case, a highly reliable estimated internal temperature can be obtained, and consequently, determinations regarding the first warning state and the second warning state can be performed with a high degree of reliability. Note that the oil temperature of the drive power source may include any related oil temperature, such as an oil temperature of engine oil, an oil temperature of a transaxle, and the like.

The driver temperature evaluation unit preferably determines that a state pertaining to the temperature of the electric pump driver corresponds to the first warning state at a stage where the internal temperature of the electric pump driver (including the internal temperature estimated as described above) has reached a warning region set less than a critical or threshold temperature of the electric pump driver. In this structure, at less than the critical or threshold temperature of the electric pump driver, the power source of the electric pump driver is cut off so that the electric pump driver does not generate additional heat. Therefore, it is possible to reliably protect the electric pump driver even if there is some degree of error in the temperature detection or the like.

As explained above, the electric pump driver may be reliably protected from heat damage by an electric pump driver protection functionality, which may be achieved by the drive control device according to this aspect of the present invention. Therefore, the electric pump driver may be disposed in a location with a severe temperature environment, such as a drive power source storage chamber that accommodates the drive power source. As a consequence, the electric pump driver has improved layout flexibility.

### BRIEF DESCRIPTION OF THE DRAWINGS

FIG. 1 is a skeleton diagram showing the schematic structure of a drive unit and a hydraulic control system;

FIG. 2 is a block diagram of a drive control device;

FIG. 3 is a flowchart showing the flow of processing for evaluating a state of an electric pump driver;

FIG. 4 is a flowchart showing the flow of second warning interrupt processing;

FIG. 5 is a flowchart showing the flow of first warning interrupt processing;

FIG. 6 is a time chart diagram for the second warning interrupt processing;

FIG. 7 is a time chart diagram for the first warning interrupt processing;

FIG. 8 is a time chart diagram for the first warning interrupt processing according to another embodiment; and

FIG. 9 is a block diagram of a drive control device according to another embodiment.

### DETAILED DESCRIPTION OF THE EMBODIMENTS

[Overall Structure of Drive Unit]

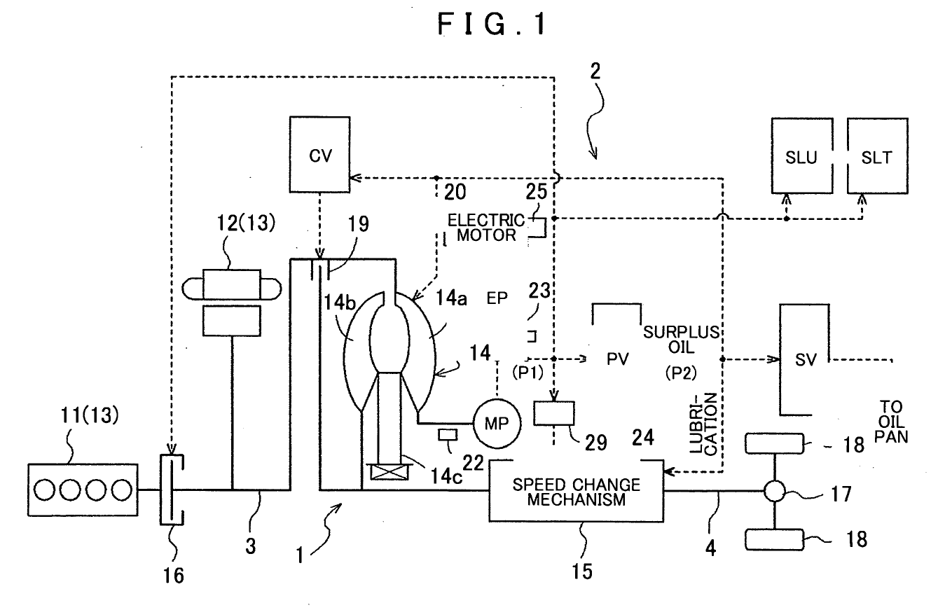

Hereinafter, a drive control device according to the various aspects the present invention will be described using embodiments wherein the present invention is applied as a drive control device for a hybrid vehicle-running drive unit as examples. A schematic structure of a drive unit 1 will be explained first based on FIG. 1. FIG. 1 is a skeleton diagram showing the schematic structure of the drive unit 1 and a hydraulic control system 2. Note that in FIG. 1, solid lines indicate a transmission path for a driving force and dashed lines indicate a supply path of operating oil.

As illustrated in FIG. 1, the drive unit 1 includes an engine 11 and a rotary electric machine 12 serving as drive power sources 13 for driving a vehicle. The engine 11 is connected with a drive member 3 via a transmission clutch 16, and the rotary electric machine 12 is also connected with the drive member 3. Accordingly, the engine 11 and the rotary electric machine 12 are connected in series via the transmission clutch 16, and thus structure the drive unit 1 for use in a parallel type hybrid vehicle.

The rotary electric machine 12 is electrically connected with an electric storage device (not shown) such as a battery or a capacitor. The rotary electric machine 12 is structured so as to function as a motor that generates motive power when electric power is supplied, and also function as a generator that generates electric power when a supply of motive power is received. Provided between the engine 11 and the rotary electric machine 12 is a transmission clutch 16 that is capable of transmitting and blocking motive power generated by the engine 11. The transmission clutch 16 receives a supply of operating oil having a line pressure PI described later, and operation of the transmission clutch 16 is controlled by a hydraulic control valve (not shown).

In the drive unit 1, the transmission clutch 16 released during start-off and low-speed travel of the vehicle, wherein the vehicle travels with the engine 11 stopped and only a rotational driving force of the rotary electric machine 12 transmitted to a wheel 18. At such time, the rotary electric machine 12 receives a supply of electric power from the electric storage device (not shown) to generate a driving force. When a rotational speed (i.e., a vehicle running speed) of the rotary electric machine 12 reaches or exceeds a fixed speed, the transmission clutch 16 is engaged so that the engine 11 starts cranking. Following start-up of the engine 11, the rotational driving forces of both the engine 11 and the rotary electric machine 12 are transmitted to the wheel 18 to run the vehicle. In this case, depending on the charge state of the electric storage device, the rotary electric machine 12 can either generate electric power using the rotational driving force of the engine 11 or generate a driving force using the electric power supplied from the electric storage device. During deceleration of the vehicle, the transmission clutch 16 is released and the engine 11 stopped, with the rotary electric machine 12 generating electric power using a rotational driving force transmitted from the wheel 18. The electric power generated by the rotary electric machine 12 is accumulated in the electric storage device. While the vehicle is stopped, both the engine 11 and the rotary electric machine 12 are stopped and the transmission clutch 16 is released.

A torque converter 14 is provided on a downstream side of transmission from the drive power source 13. The structure of the torque converter 14 includes a pump impeller 14a serving as an input-side rotational member connected with the drive member 3; a turbine runner 14b serving as an output-side rotational member connected with a speed change mechanism 15; and a stator 14c that is provided between the pump impeller 14a and the turbine runner 14b, and has a one-way clutch. The torque converter 14 transmits a driving force between the driving-side pump impeller 14a and the driven-side turbine runner 14b via operating oil that fills the inside of the torque converter 14.

The torque converter is also provided with a lock-up clutch 19, and when the lock-up clutch 19 is engaged, the driving force of the drive power source 13 is directly transmitted to the speed change mechanism 15 without using operating oil as an intermediary. Operating oil with an adjusted pressure P2 described later is supplied to the torque converter 14, including the lock-up clutch 19.

When a speed of the speed change mechanism 15 is changed, the lock-up clutch 19 is released and the driving force is transmitted via operating oil. When the vehicle starts off, the lock-up clutch 19 remains engaged and the vehicle starts off using the driving force of the rotary electric machine 12. Thus, when the vehicle starts off, the lock-up clutch 19 can be engaged to suppress slipping of the torque converter 14, making it possible to increase a start-off acceleration performance of the vehicle, and heat caused by operating oil inside the torque converter 14 can be suppressed to increase energy efficiency.

The speed change mechanism 15 is connected on a downstream side of the torque converter 14 from the drive member 3. Using the speed change mechanism 15, a rotation of the driving force from the drive power source 13 transmitted via the torque converter 14 can be changed to a predetermined shift ratio and transmitted to the wheel 18 side. The speed change mechanism 15 may be embodied by a stepped automatic transmission, and includes friction engagement elements such as clutches and brakes that engage and release rotational elements of a gear mechanism that generates shift ratios of various speeds. The friction engagement elements of the speed change mechanism 15 receive a supply of operating oil with the line pressure P1 described later, and operation of the friction engagement elements is controlled by a hydraulic control valve 29 used for a shift control. Note that the speed change mechanism 15 may be structured by a stepless automatic transmission, and in such case, operating oil with the line pressure P1 is supplied to operate pulleys on the driving side and driven side of the stepless automatic transmission so as to perform a shift operation of the stepless automatic transmission.

An output member 4 is connected on a downstream side of the speed change mechanism 15 from the torque converter 14, and the output member 4 is connected with the wheel 18 via a differential device 17. Accordingly, the rotational driving force transmitted from the drive power source 13 to the drive member 3 is shifted by the speed change mechanism 15 and transmitted to the output member 4, after which the rotational driving force transmitted to the output member 4 is then transmitted to the wheel 18 via the differential device 17.

[Structure of Hydraulic Control System]

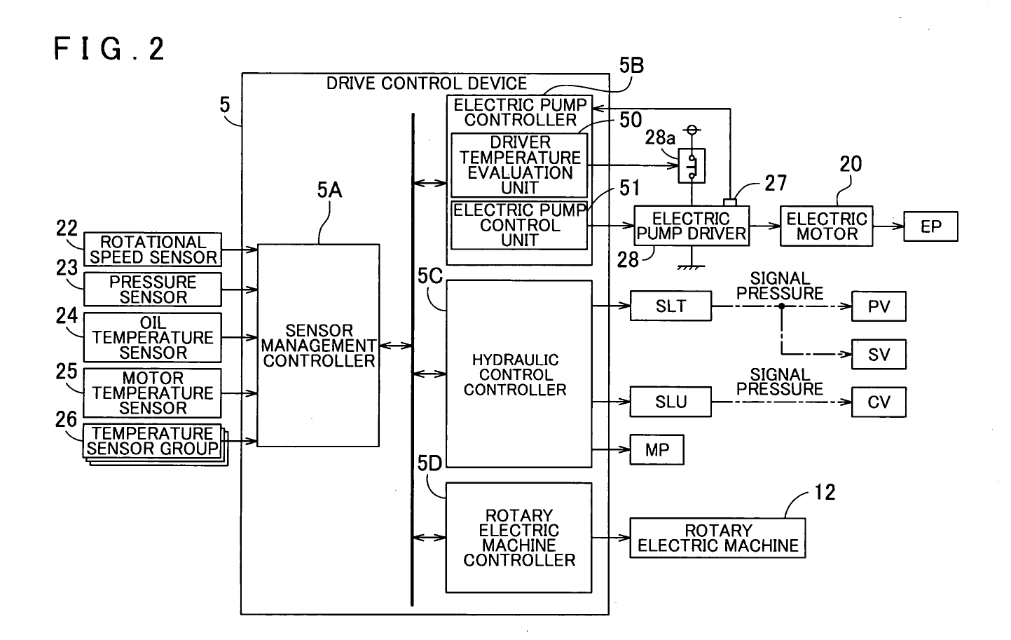

The structure of a hydraulic control system 2 will be explained based on FIGS. 1 and 2. FIG. 2 is a block diagram showing functions and structural elements related to the present invention in a drive control device 5 for the drive unit 1. As FIG. 1 shows, the structure of the hydraulic control system 2 includes two types of pumps, a mechanical pump MP and an electric pump EP, which serve as hydraulic pressure sources for supplying operating oil to portions of the drive unit 1. The mechanical pump MP is an oil pump driven by the driving force of the drive power source 13. In this embodiment, the mechanical pump MP is connected with the pump impeller 14a of the torque converter 14, and is driven by the rotational driving force of the rotary electric machine 12 or by both the rotational driving forces of the engine 11 and the rotary electric machine 12.

As illustrated in FIGS. 1 and 2, the electric pump EP is an oil pump that supplements the mechanical pump MP is driven by the driving force of an electric motor 20 which is independent of the driving force of the drive power source 13. The electric pump EP operates in lieu of the mechanical MP to supply the required operating oil at times when the vehicle is stopped, travels at low speed or the like.

A first pressure regulator valve (primary regulator valve) PV and a second pressure regulator valve (secondary regulator valve) SV are provided, which serve as pressure regulator valves for adjusting a pressure of operating oil supplied from the mechanical pump MP and the electric pump EP to a predetermined pressure. The first pressure regulator valve PV is a pressure regulator valve that adjusts the pressure of operating oil supplied from the mechanical pump MP and the electric pump EP to the predetermined line pressure P1. The line pressure P1 (a pressure serving as a standard pressure of the hydraulic control system 2) is adjusted based on a predetermined signal pressure supplied from a linear solenoid valve SLT. The second regulator valve SV is a pressure regulator valve that adjusts the pressure of surplus oil from the first regulator valve PV to the predetermined adjusted pressure P2. Based on the signal pressure supplied from a linear solenoid valve SLT, surplus oil discharged from the first regulator valve PV is adjusted to the adjusted pressure P2 while a portion thereof is drained to an oil pan.

The linear solenoid valve SLT receives a supply of operating oil of the line pressure P1 adjusted by the first regulator valve PV, and adjusts a valve opening in accordance with a control command value (referred to below as an SLT command value) output from the drive control device 5. Thus, operating oil of the predetermined signal pressure in accordance with the SLT command value is output to the first regulator valve PV and the second regulator valve SV. Operating oil of the line pressure P1 adjusted by the first regulator valve PV is supplied to the transmission clutch 16, and friction engagement elements such as the clutches and brakes provided in the speed change mechanism 15. Operating oil of the adjusted pressure P2 adjusted by the second regulator valve SV is supplied to the torque converter 14, lubricating oil passages of the speed change mechanism 15, and a lock-up control valve CV for controlling the lock-up clutch 19.

The lock-up control valve CV is a valve for controlling an operation to engage or release the lock-up clutch 19, and receives a supply of operating oil of the adjusted pressure P2 adjusted by the second regulator valve SV. By opening and closing in accordance with the predetermined signal pressure from the linear solenoid valve SLU for lock-up control, the lock-up control valve CV supplies operating oil of the adjusted pressure P2 adjusted by the second regulator valve SV to a hydraulic chamber of the lock-up clutch 19, and controls an operation to engage or release the lock-up clutch 19.

[Structure of Drive Control Device]

The drive control device 5 will be explained next based on FIG. 2. As elements related to this embodiment of the present invention, the drive control device 5 includes a controller for sensor management 5A that controls the status of various sensors; a controller for an electric pump 5B that controls the operation of the electric pump EP, a controller for hydraulic control 5C that generates and outputs a control signal to various hydraulic instruments, and a controller for a rotary electric machine 5D that controls the operation of the rotary electric machine 12. These controllers may be embodied by computers with a communication function such that data transmission is possible among one other via a network.

The sensor management controller 5A is connected with a rotational speed sensor 22, a pressure sensor 23, an oil temperature sensor 24, a motor temperature sensor 25, and so on. The rotational speed sensor 22 is attached to an input portion of the mechanical pump MP in order to detect a rotational speed of the mechanical pump MP. The rotational speed of the input portion of the mechanical pump MP is detected by the rotational speed sensor 22. The pressure sensor 23 is provided in a merged oil passage that merges with an oil passage connected to a discharge port of the mechanical pump MP and an oil passage connected to a discharge port of the electric pump EP. The pressure of operating oil supplied from the mechanical pump MP and the electric pump EP is detected by the pressure sensor 23. In this embodiment, the oil temperature sensor 24 is provided inside the first regulator valve PV. The temperature of operating oil (e.g. operating oil discharged from the electric pump EP in a state where only the electric pump EP is driving) discharged from the mechanical pump MP and the electric pump EP is detected by the oil temperature sensor 24 as an oil temperature of a transaxle. Note that the oil temperature sensor 24 may be connected at a different location. For example, the oil temperature sensor 24 may be connected with an oil passage connected to the discharge port of the electric pump EP, or an internal portion of the electric pump EP, or the discharge port of the electric pump EP. The motor temperature sensor 25 detects a temperature of the electric motor 20 used for driving the electric pump EP, and may be structured so as to detect the temperature of the surface of the electric motor 20, for example. In addition, a temperature sensor group 26 that detects various temperatures such as the temperatures of engine oil, engine coolant, and a cooling medium of the rotary electric machine 12, is also connected with the sensor management controller 5A. The sensor management controller 5A processes detected values from these sensors, and sends either such detected values or a result obtained by judgment processing or the like using a predetermined algorithm to other controllers including the electric pump controller 5B, the hydraulic controller 5C and the rotary electric machine controller 5D.

The rotary electric machine controller 5D is connected with the rotary electric machine 12, which includes a control circuit, and a drive control of the rotary electric machine 12 is performed based on a control signal from the rotary electric machine controller 5D.

The hydraulic control controller 5C is connected with the linear solenoid valve SLT and the linear solenoid valve SLU used for a lock-up control. The SLT command value, which is the control signal of the linear solenoid valve SLT, is determined by the hydraulic control controller 5C based on various types of vehicle information such as a running load and an accelerator opening, and a corresponding control signal is output to the linear solenoid valve SLT. The linear solenoid valve SLU adjusts the valve opening in accordance with the control command value output from the drive control device 5, whereby operating oil of the predetermined signal pressure in accordance with the command value is output to the lock-up control valve

The electric pump controller 5B is connected with an electric pump driver 28 that controls a drive current to the electric motor 20 serving as an electric machine for driving the electric pump EP. The electric pump may be stopped when the electric pump driver 28 drops the drive current to a low value. The electric pump driver 28 is electrically connected with the electric storage device via a relay 28a. Note that although not shown in the figure, at least the engine 11 and the rotary electric machine 12 among the structural elements of the drive unit 1 are accommodated in an engine compartment of the vehicle. In the present embodiment, the engine compartment corresponds to a drive power source storage chamber. Furthermore, the drive control device 5 and the electric pump driver 28 are arranged within the engine compartment integrally or separately with any of the structural elements of the drive unit 1.

An opening/closing operation of the relay 28a is performed based on a control signal from the electric pump controller 5B. The electric pump controller 5B closing the relay 28a and sending a drive signal to the electric pump driver 28 results in the supply of electric power from the electric storage device to the electric motor 20 and driving of the electric pump EP. If the relay 28a is open and the supply of electric power from the electric storage device to the electric pump driver 28 is cut off, then the electric pump EP stops and the supply of electric power to the electric pump driver 28 is also stopped. Therefore, the electric pump driver 28 naturally stops generating heat as well. In this embodiment, the electric pump driver 28 is incorporated with a driver temperature sensor 27 that detects an internal temperature of the electric pump driver 28. A detected value of the internal temperature generated by the driver temperature sensor 27 is sent to the electric pump controller 5B.

The electric pump controller 5B structures a driver temperature evaluation unit 50 and an electric pump control unit 51. The driver temperature evaluation unit 50 evaluates the temperature of the electric pump driver 28 based on the detected value of the internal temperature from the driver temperature sensor 27. The electric pump control unit 51 stops driving of the electric pump EP, or opens the relay 28a and cuts off the power source of the electric pump driver 28, based on the evaluation result of the driver temperature evaluation unit 50.

In this embodiment, the driver temperature evaluation unit 50 sets a first warning temperature region with a width having a predetermined range on a low-temperature side from a maximum operable temperature (a limit temperature) of the electric pump driver 28, and further sets a second warning temperature region with a width having a predetermined range on a low-temperature side of the first warning temperature region. If the internal temperature detected by the driver temperature sensor 27 falls within the first warning temperature region, then the driver temperature evaluation unit 50 determines a first warning state has been reached. If the internal temperature detected by the driver temperature sensor 27 falls within the second warning temperature region, then the driver temperature evaluation unit 50 determines a second warning state has been reached. Namely, the first warning state and the second warning state are prescribed states that pertain to the temperature of the electric pump driver 28. The electric pump control unit 51 performs various controls based on the evaluation result generated by the driver temperature evaluation unit 50. While this embodiment describes the use of warning temperature regions having predetermined range, the warning states may also be triggered when the internal temperature exceeds a present temperature. In such a case, the second warning state would be triggered when a first temperature set point has been exceeded. Further, the first warning state would be triggered when a second temperature set point, higher than the first temperature set point, has been exceeded.

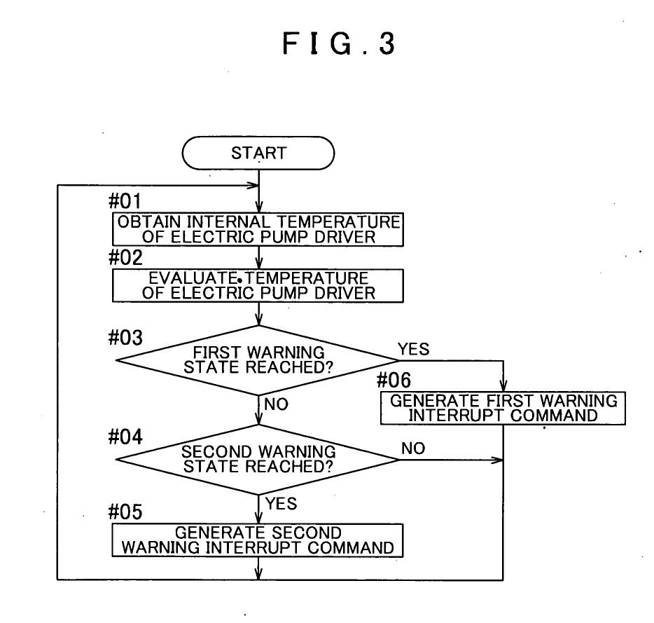

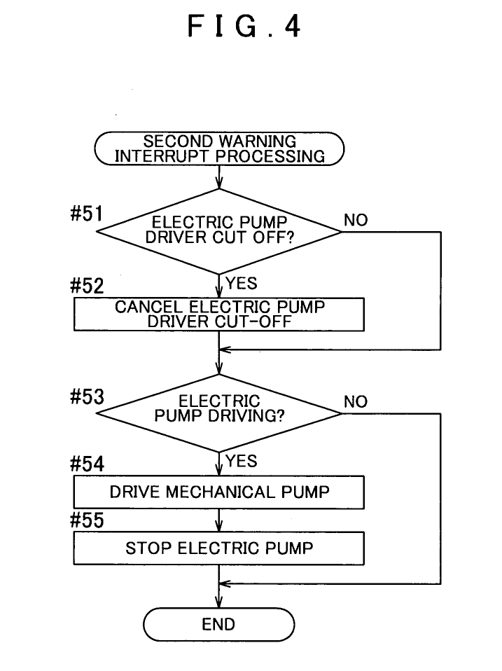

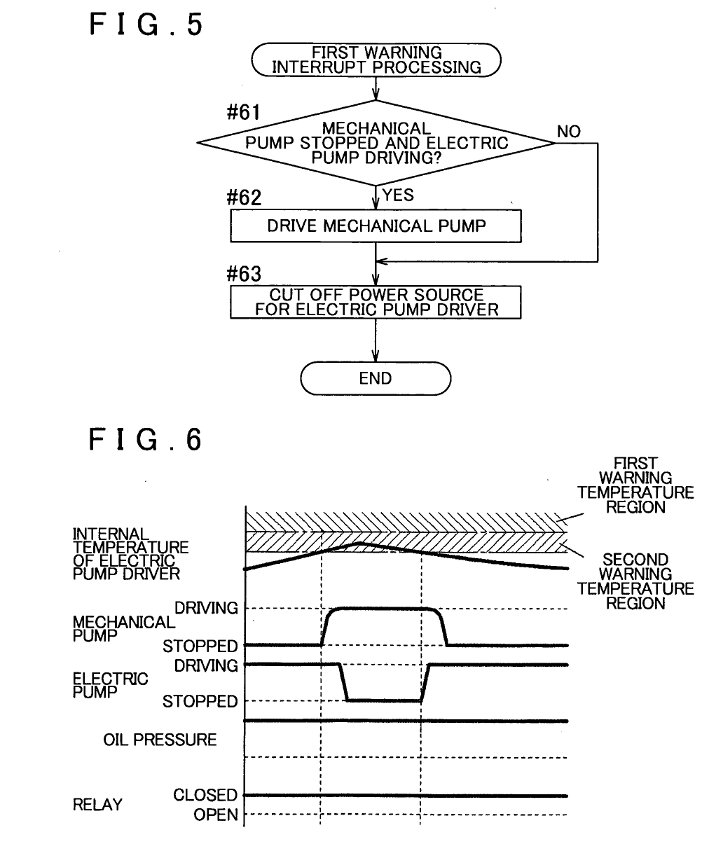

The control performed by the electric pump controller 5B based on the internal temperature detected by the driver temperature sensor 27 will be explained using FIGS. 3, 4, and 5. FIG. 3 shows a main operating routine of judgment processing in the driver temperature evaluation unit 50, while FIGS. 4 and 5 show emergency interrupt operating routines of the electric pump control unit 51 that are based on the evaluation result generated by the driver temperature evaluation unit 50. First, the internal temperature of the electric pump driver 28 is obtained from the driver temperature sensor 27 (#01). Based on the obtained internal temperature, the status of the electric pump driver 28 is evaluated (#02). Based on the evaluation result, a check is performed as to whether the internal temperature entered the first warning temperature region and a determination made that the first warning state has been reached (#03). If there was no determination that the first warning state had been reached (NO branch at #03), then a check is performed as to whether the internal temperature entered the second warning temperature region and a determination made that the second warning state has been reached (#04). If there was no determination that the second warning state had been reached in this check (NO branch at #04), then it is determined that the temperature status of the electric pump driver 28 is not provoking a warning, and the routine returns to step #01. If there was a determination that the second warning state had been reached in the check at step #04 (YES branch at #04), then a second warning interrupt command is generated (#05) and the routine returns to step #01. If there was a determination that the first warning state had been reached in the check at step #03 (YES branch at #03), then a first warning interrupt command is generated (#06) and the routine returns to step #01.

Once the second warning interrupt command is generated, the electric pump control unit 51 performs second warning interrupt processing as shown in FIG. 4. FIG. 6 shows a time chart diagram for the second warning interrupt processing. In this processing, a check is first performed as to whether the power source of the electric pump driver 28 is cut off while the relay 28a is open (#51). If the power source of the electric pump driver 28 is cut off (YES branch at #51), then the relay 28a is closed and the electric pump driver 28 is connected with the power source (#52). A check is further performed as to whether the electric pump EP is driving (#53). If the electric pump EP is stopped (NO branch at #04), then the processing is ended. If the electric pump EP is driving (YES branch at #04), then the mechanical pump MP is driven (#54). Once the mechanical pump MP has reached a predetermined rotational speed after a predetermined time, a control signal is sent to the electric pump driver 28 to stop the electric pump EP (#55). FIG. 6 shows that by stopping the electric pump EP, the internal temperature of the electric pump driver 28 lowers and leaves the warning regions.

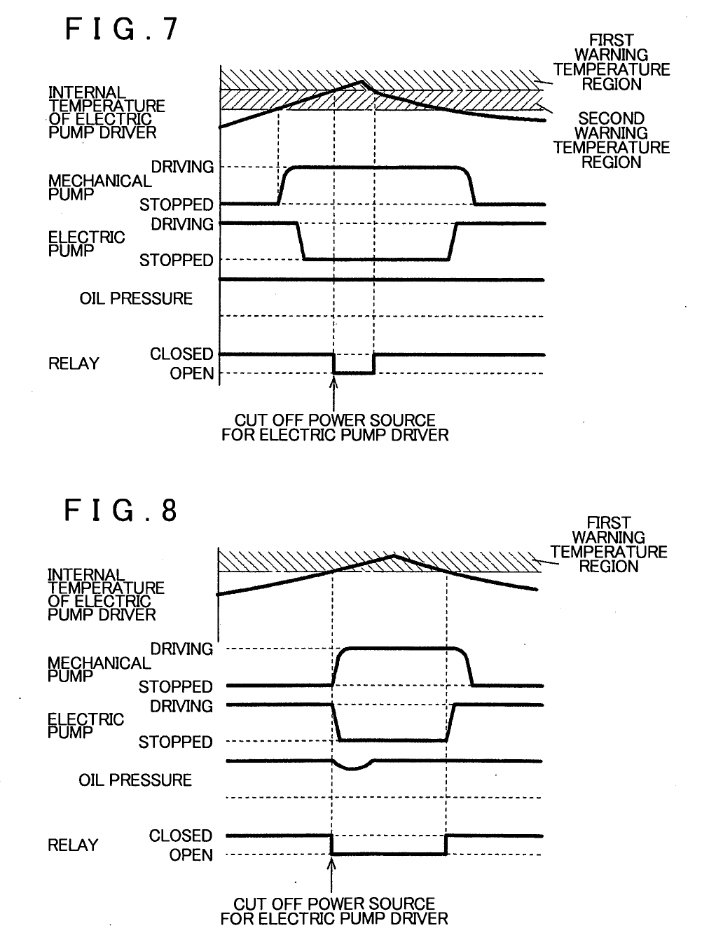

Meanwhile, once the first warning interrupt command is generated, the electric pump control unit 51 performs first warning interrupt processing as shown in FIG. 5. FIG. 7 shows a time chart diagram for the first warning interrupt processing. In this processing, a check is first performed as to whether the mechanical pump MP is stopped and the electric pump EP is driving (#61). If the mechanical pump MP is stopped and the electric pump EP is driving (YES branch at #61), then the mechanical pump MP is driven (#62). The relay 28a is subsequently opened and the power source of the electric pump driver 28 is cut off (#63). If the mechanical pump MP is not stopped and/or the electric pump EP is not driving (NO branch at #61), then the routine proceeds to step #63 where the power source of the electric pump driver 28 is cut off. By cutting off the power source of the electric pump driver 28, the electric pump driver 28 naturally stops generating heat. Therefore, as shown in FIG. 7, the internal temperature of the electric pump driver 28 lowers and leaves the emergency regions.

The time chart of FIG. 7 assumes that the second warning interrupt command is generated before generation of the first warning interrupt command, and in reality, this is the flow of such a control. However, in another embodiment where the second warning state, i.e., the second warning temperature region, is not set and the second warning interrupt command is not generated, when the first warning interrupt command is generated, the relay 28a is opened and the power source of the electric pump driver 28 is cut off until the first warning interrupt command is cancelled. FIG. 8 is a time chart illustrating this control.

According to the drive control device 5, if the driver temperature evaluation unit 50 determines that the first warning state has been reached, then the power source of the electric pump driver 28 is cut off after driving the mechanical pump MP as necessary in order to promptly lower the internal temperature of the electric pump driver 28. According to the embodiment where the second warning state is set, if the driver temperature evaluation unit 50 determines that the second warning state has been reached during operation of the electric pump, then a command is given to drive the mechanical pump MP and a control signal is sent to the electric pump driver 28 in order to stop the electric motor 20 of the electric pump EP, which thus suppresses a rise in the internal temperature of the electric pump driver 28.

### Other Embodiments

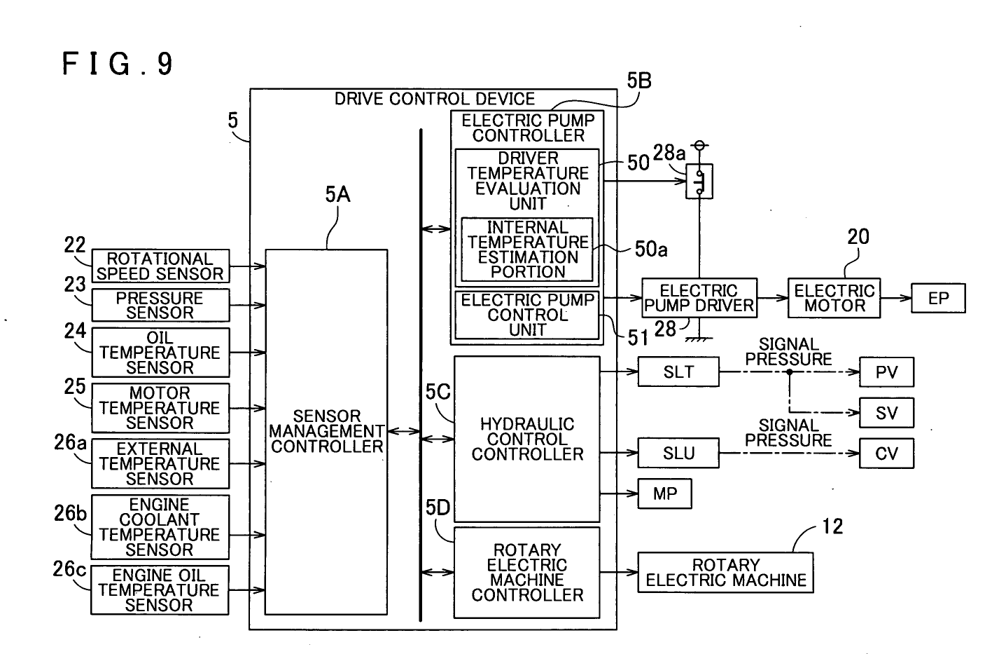

(1) In the embodiment described above, the internal temperature of the electric pump driver 28 is directly detected by the driver temperature sensor 27. Alternatively, the driver temperature evaluation unit 50 may calculate an estimated value for the internal temperature of the electric pump driver 28, based on a temperature of the electric motor 20 detected by the motor temperature sensor 25 or other environmental temperatures. Determinations regarding whether the first warning state and the second warning state have been reached can thus be made based on this estimated internal temperature. In such an embodiment, as FIG. 9 shows, the driver temperature evaluation unit 50 structures an internal temperature estimation portion 50a. The internal temperature estimation portion 50a is connected with the sensor management controller 5A, and receives detected values from at least one of a plurality of environmental temperature sensors, such as an external temperature sensor 26a, an engine coolant temperature sensor 26b, and an engine oil temperature sensor 26c. The internal temperature estimation portion 50a designates an outside air temperature as Ta, an engine coolant temperature as Tb, and an engine oil temperature as Tc, and uses these as parameters to derive an estimated internal temperature T0. In such case, the internal temperature estimation portion 50a stores a regression equation F shown below, where T0=F(Ta, Tb, Tc), in a table format, whereby the estimated internal temperature can be easily calculated. This type of regression equation F can be found in advance using a statistical technique such as regression analysis. Naturally, a method may be similarly adopted where the temperature of the electric motor 20 as detected by the motor temperature sensor 25 is designated as Tm, and the estimated internal temperature is calculated using a regression equation T0=G(Tm) or T0=J(Tm, Ta, Tb, Tc). Accordingly, the driver temperature evaluation unit 50 calculates the estimated internal temperature from a combination of detected values such as the temperature of the electric motor 20, the outside air temperature, the engine coolant temperature, and the engine oil temperature. Based on the estimated internal temperature, a determination can then be made regarding the warning state of the electric pump driver 28.

(2) In the embodiment described above, an example was given where a number of various sensors are connected with the sensor management controller 5A, and the sensor management controller 5A processes the detected values from these sensors. The sensor management controller 5A then sends either such detected values or a result obtained by judgment processing or the like using a predetermined algorithm to controllers requiring the detected values. However, instead of the structure described above, a structure may be adopted where the various sensors are directly connected with controllers that require such detected values. Alternatively, a structure may be adopted where the driver temperature sensor 27 is connected with the sensor management controller 5A and a detected value is sent therefrom to the electric pump controller 5B.

(3) In the embodiment describe above, an example was given where the electric pump driver 28 is disposed in the engine chamber (drive power source storage chamber) that accommodates the engine 11 and the rotary electric machine 12. However, the embodiments of the present invention are not limited to this example. In other words, the electric pump driver 28 may be disposed at a location other than the drive power source storage chamber.

(4) In the embodiment described above, an example was illustrated where the drive control device was applied to a hybrid vehicle. However, the range of applicability of the drive control device according to the present invention is not limited to such an example. The drive control device according to the present invention may also be applied to a vehicle other than a hybrid vehicle, such as an electric vehicle that uses only the rotary electric machine 12 as a drive power source or a vehicle that uses only the engine 11 as a drive power source. In particular, an idling stop vehicle not provided with the rotary electric machine 12 which stops the engine 11 during a vehicle stop and drives the electric pump EP to supply hydraulic pressure is preferable. In addition, the drive control device according to the present invention may also be applied to a stationary drive unit.

Thus apparatuses and methods consistent with the present invention are well suited for application in a drive control device for a drive unit having a drive member drivingly connected with a drive power source, a mechanical pump operated by a rotational driving force of the drive member, an electric pump that supplements the mechanical pump, and an electric pump driver that controls a drive current to a motor of the electric pump.

The various aspects of the present invention is described herein with reference to flowchart illustrations. It will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded into a computer or other programmable data processing apparatus to cause a series of operational steps to be performed in the computer or other programmable apparatus to produce a computer implemented process such that the instructions that execute in the computer or other programmable apparatus provide steps for implementing the functions specified in the flowchart block or blocks.

And each block of the flowchart illustrations may represent a module, segment, or portion of code, which includes one or more executable instructions for implementing the specified logical function(s). It should also be noted that in some alternative implementations, the functions noted in the blocks may occur out of order. For example, two blocks shown in succession may in fact be executed substantially concurrently or the blocks may sometimes be executed in reverse order, depending upon the functionality involved.

What is claimed is:

1. A drive control device for a drive unit, comprising:
a drive member operatively connected with a drive power source;
a mechanical pump operated by a rotational driving force of the drive member and configured to supply pressurized oil;
an electric pump configured to supply pressurized oil; and
an electric pump driver that controls a drive current to a motor of the electric pump, the drive control device further comprising:
a driver temperature evaluation unit that evaluates a temperature of the electric pump driver; and
an electric pump control unit that cuts off a power source of the electric pump driver if it is determined by the driver temperature evaluation unit during operation of the electric pump driver that a prescribed first warning state, which is a state pertaining to the temperature of the electric pump driver, has been reached.

2. The drive control device according to claim 1, wherein
if the driver temperature evaluation unit determines that a state pertaining to the temperature of the electric pump driver corresponds to the first warning state, then the mechanical pump is driven and the motor of the electric pump is stopped.

3. The drive control device according to claim 1, wherein
if the driver temperature evaluation unit determines that a state pertaining to the temperature of the electric pump driver corresponds to a second warning state set at a lower temperature state than the first warning state, then the mechanical pump is driven before cutting off the power source of the electric pump driver.

4. The drive control device according to claim 1, wherein
the driver temperature evaluation unit determines a warning state based on a detected value for an internal temperature of the electric pump driver.

5. The drive control device according to claim 1, wherein
the driver temperature evaluation unit calculates an estimated value for the internal temperature of the electric pump driver based on an environmental temperature, and determines the warning state based on the estimated value for the internal temperature.

6. The drive control device according to claim 5, wherein
the environmental temperature is at least any one of an outside air temperature, a coolant temperature of the drive power source, and an oil temperature of the drive power source, and a combination thereof.

7. The drive control device according to claim 1, wherein
the driver temperature evaluation unit determines that a stat
e pertaining to the temperature of the electric pump driver corresponds to the first warning state at a stage where the internal temperature of the electric pump driver has reached a warning region set less than maximum operable temperature of the electric pump driver.

8. The drive control device according to claim 1, wherein
the electric pump driver is disposed in a drive power source storage chamber that accommodates the drive power source.

9. The drive control device according to claim 2, wherein
if the driver temperature evaluation unit determines that a state pertaining to the temperature of the electric pump driver corresponds to a second warning state set at a lower temperature state than the first warning state, then the mechanical pump is driven before cutting off the power source of the electric pump driver.

10. The drive control device according to claim 9, wherein
the driver temperature evaluation unit determines a warning state based on a detected value for an internal temperature of the electric pump driver.

11. The drive control device according to claim 9, wherein
the driver temperature evaluation unit calculates an estimated value for the internal temperature of the electric pump driver based on an environmental temperature, and determines the warning state based on the estimated internal temperature.

12. The drive control device according to claim 11, wherein
the environmental temperature is at least any one of an outside air temperature, a coolant temperature of the drive power source, and an oil temperature of the drive power source, and a combination thereof.

13. The drive control device according to claim 2, wherein
the driver temperature evaluation unit determines a warning state based on a detected value for an internal temperature of the electric pump driver.

14. The drive control device according to claim 2, wherein
the driver temperature evaluation unit calculates an estimated value for the internal temperature of the electric pump driver based on an environmental temperature, and determines the warning state based on the estimated internal temperature.

15. The drive control device according to claim 14, wherein
the environmental temperature is at least any one of an outside air temperature, a coolant temperature of the drive power source, and an oil temperature of the drive power source, and a combination thereof.

16. The drive control device according to claim 3, wherein
the driver temperature evaluation unit determines a warning state based on a detected value for an internal temperature of the electric pump driver.

17. The drive control device according to claim 3, wherein
the driver temperature evaluation unit calculates an estimated value for the internal temperature of the electric pump driver based on an environmental temperature, and determines the warning state based on the estimated internal temperature.

18. The drive control device according to claim 17, wherein
the environmental temperature is at least any one of an outside air temperature, a coolant temperature of the drive power source, and an oil temperature of the drive power source, and a combination thereof.

19. The drive control device according to claim 10, wherein
the driver temperature evaluation unit determines that a state pertaining to the temperature of the electric pump driver corresponds to the first warning state at a stage where the internal temperature of the electric pump driver has reached a warning region set less than a maximum operable temperature of the electric pump driver.

20. The drive control device according to claim 10, wherein
the electric pump driver is disposed in a drive power source storage chamber that accommodates the drive power source.
